(19) United States
(12) Patent Application Publication
(10) Pub. No.: US 2007/0019538 A1
(43) Pub. Date: Jan. 25, 2007

(54) Symbol Synchronization for OFDM Systems

(75) Inventors: Guozhu Long, Fremont, CA (US); Yu-Wen Chang, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MediaPhy Corporation, San Jose, CA (US)

(21) Appl. No.: 11/458,340

(22) Filed: Jul. 18, 2006

Related U.S. Application Data
(60) Provisional application No. 60/701,000, filed on Jul. 19, 2005.

(51) Int. Cl. H04J 11/00

(52) U.S. Cl. 370/208

(57) ABSTRACT

Symbol synchronization in a communication system is carried out as follows. A plurality of symbols corresponding to a transmitted signal is received, where the plurality of symbols include guard intervals. Peak correlation is obtained using the plurality of received symbols. The second derivative of the peak correlation is obtained, and one or more peaks within a corresponding guard interval are identified from the second derivative. A symbol start time for each received symbol is estimated based on the second derivative of the peak correlation.

### CROSS-REFERENCES TO RELATED APPLICATIONS

This application claims the benefit of U.S. Provisional Application No. 60/701,000, filed Jul. 19, 2005, which is incorporated by reference in its entirety for all purposes.

### BACKGROUND OF THE INVENTION

The invention relates to communications systems, and more particularly to symbol synchronization for OFDM systems.

In communications systems, the information-bearing signals are transmitted from the source to the destination through a communication channel which causes signal distortion. Depending on the communication channel characteristics, appropriate signal modulation techniques are used.

OFDM (Orthogonal Frequency Division Multiplexing) is gaining popularity in broadband communications. In OFDM systems, the data signal is distributed among many equally-spaced, mutually-orthogonal sub-carriers. OFDM modulation is typically implemented through the IDFT (Inverse Discrete Fourier Transform, typically implemented more efficiently as IFFT—Inverse Fast Fourier Transform) in the transmitter, and the demodulation is typically implemented through the DFT (Discrete Fourier Transform, typically implemented more efficiently as FFT—Fast Fourier Transform).

The transmitted signal is grouped as DFT symbols, each of which consists of all the output samples of one IDFT operation. In order to avoid inter-symbol-interference (ISI), the DFT symbols are usually separated by some guard intervals (GI). One type of commonly used guard interval is called cyclic prefix (CP), which is the duplication of the last N_{g} samples of the DFT symbol of Nᵤ samples. FIG. 1 illustrates an OFDM symbol with cyclic prefix. The guard interval and the DFT symbol form an OFDM symbol Nₛ=Nᵤ+N_{g} samples.

Given a search window Nₛ, an FFT size Nᵤ and guard interval length N_{g}, the initial symbol start time, n′₀, may be obtained by Equation 1:

$${n}_{0}^{′} = {arg max}_{n = 0 , … , N - 1} \{ \vert {\sum }_{i = n}^{n + {N}_{g} - 1} x ( i ) \cdot {x}^{*} ( i + {N}_{u} ) \vert \} \qquad Eq . ( 1 )$$

Note that the operation to compute absolute value may be replaced by alternative operations, such as magnitude square. The search window Nₛ is set to Nᵤ+N_{g}. Since n′₀ is calculated from only one symbol worth of data, the value is noisy at low signal to noise ratio (SNR). A more accurate estimate of symbol start time, n″₀ is then computed by averaging data over a few symbols around n′₀ as indicated by Equation 2:

$${n}_{0}^{″} = {arg max}_{n} \{ T ( n ) \} , \\ T ( n ) = {\sum }_{i = 0}^{{K}^{′} - 1} {\sum }_{j = n}^{n + {N}_{g} - 1} x ( i \cdot N + j ) \cdot {x}^{*} ( i \cdot N + j + {N}_{u} ) \} , \\ {n}_{0}^{′} - {N}_{g} - Δ \leq n \leq {n}_{0}^{′} + {N}_{g} + Δ , \\ Δ = \frac{{N}_{g}}{r} \qquad Eq . ( 2 )$$

Here, Δ and K′ are the window calculation expansion and the number of symbols for averaging, and r and K′ are integers greater than or equal to 1. For example, r may be set to 16 and K′ may be set to 3 to 5.

The signal samples used in the correlation T(n) are received signals. Although the N_{g} samples of CP equal exactly the last Ng samples of the DFT symbol in the transmitter, they are not the same at the receiver due to channel distortion. In fact, the first L samples in CP are affected by the previous symbol while the corresponding samples in the DFT symbol are affected by the samples in the same DFT symbol. As a result, this simple peak correlation technique typically works well under relatively good channel conditions, but fails to properly identify the symbol boundaries where the channel conditions are more severe because of the presence of, for example, multi-path and Doppler Effect.

Therefore, there is a need for techniques which can effectively and accurately identify the OFDM symbol boundary even in the presence of severe channel conditions.

### BRIEF SUMMARY OF THE INVENTION

In accordance with an embodiment of the invention, symbol synchronization in a communication system is carried out as follows. A plurality of symbols corresponding to a transmitted signal are received, where he plurality of symbols include guard intervals. A peak correlation is obtained using the plurality of received symbols. The second derivative of the peak correlation is obtained to identify one or more peaks each corresponding to a channel impulse response within a guard interval. A symbol start time is estimated for each received symbol based on the second derivative of the peak correlation.

In one embodiment, a position of a window of a predetermined number of samples is located to cover the one or more peaks.

In another embodiment, the predetermined number of samples is equal to or less than guard interval samples.

In another embodiment, the second derivative of the peak correlation is used to identify a window of a corresponding guard interval with a maximum spike energy.

In yet another embodiment, the plurality of symbols are OFDM symbols.

In yet another embodiment, first and second derivatives of the peak correlation are obtained using samples that are apart from one another a predetermined number of samples.

In another embodiment, after estimating the symbol start time, the guard intervals are removed from the plurality of symbols.

In accordance with another embodiment of the invention, symbol synchronization in a communication system is carried out as follows. A plurality of symbols corresponding to a transmitted signal are received, where the plurality of symbols include guard intervals. Peak correlation is obtained using the plurality of received symbols. In each guard interval, a window of samples with the maximum correlation energy based on the peak correlation is obtained. A symbol start time is estimated for each received symbol using the obtained samples.

In one embodiment, the window of samples is equal to or less than guard interval samples.

In another embodiment, after estimating the symbol start time, the guard intervals are removed from the plurality of symbols.

A further understanding of the nature and the advantages of the invention disclosed herein may be realized by reference to the remaining portions of the specification and the attached drawings.

### BRIEF DESCRIPTION OF THE DRAWINGS

FIG. 1 illustrates an OFDM symbol with cyclic prefix;

FIG. 2 shows a block diagram of an OFDM-based wireless receiver in which embodiments of the invention are implemented;

FIG. 3 depicts the correlation T(n) for an ideal channel with no distortion;

FIG. 4 is a flow chart depicting the sequence of operations carried out by the receiver in FIG. 2;

FIG. 5 is a flow chart illustrating a first technique for symbol synchronization according to one embodiment of the invention;

FIG. 6 is a flow chart illustrating an alternate technique for symbol synchronization according to another embodiment of the invention; and

FIGS. 7-10 are simulation results of exemplary multi-path channels used to illustrate some of the advantages of the present invention.

### DETAILED DESCRIPTION OF THE INVENTION

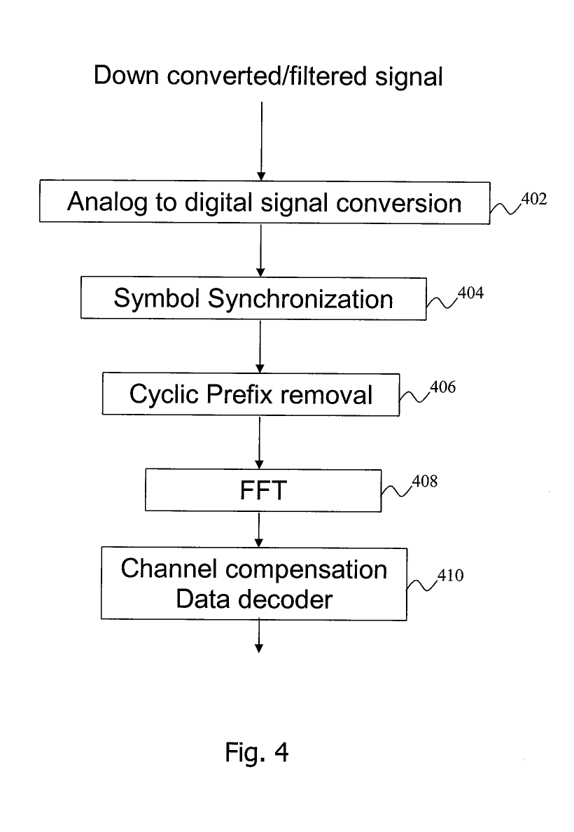

In accordance with an exemplary embodiment of the invention, FIG. 2 shows a block diagram of an OFDM-based wireless receiver in which embodiments of the invention are implemented. FIG. 4 is a flow chart which will be used to describe the operation of the receiver in FIG. 2. RF tuner 100 receives the radio-frequency signal through an antenna. The desired signal is selected by tuner 100 and down-converted and filtered through down-converter/filter block 110 in accordance with known techniques. The output of block 110 is the analog baseband signal (or passband signal at much lower frequency than the original radio frequency) which is converted into digital signal by analog to digital converter 120 using conventional techniques. This is depicted by step 402 in FIG. 4. Next, in step 404, the digital signal is grouped into symbols with symbol boundary properly identified in symbol synchronization block 130 using one of the techniques of the present invention. In step 406, the guard intervals (typically cyclic prefix) are removed by block 140 before the grouped symbols are transferred to FFT block 150. In steps 408 and 410, the output of FFT block 150 is further processed by decoder 200 in accordance with conventional techniques. The symbols are separated by some guard interval (cyclic prefix) to help prevent inter-symbol-interference (ISI). Obviously, it is critical to identify the symbol boundary properly.

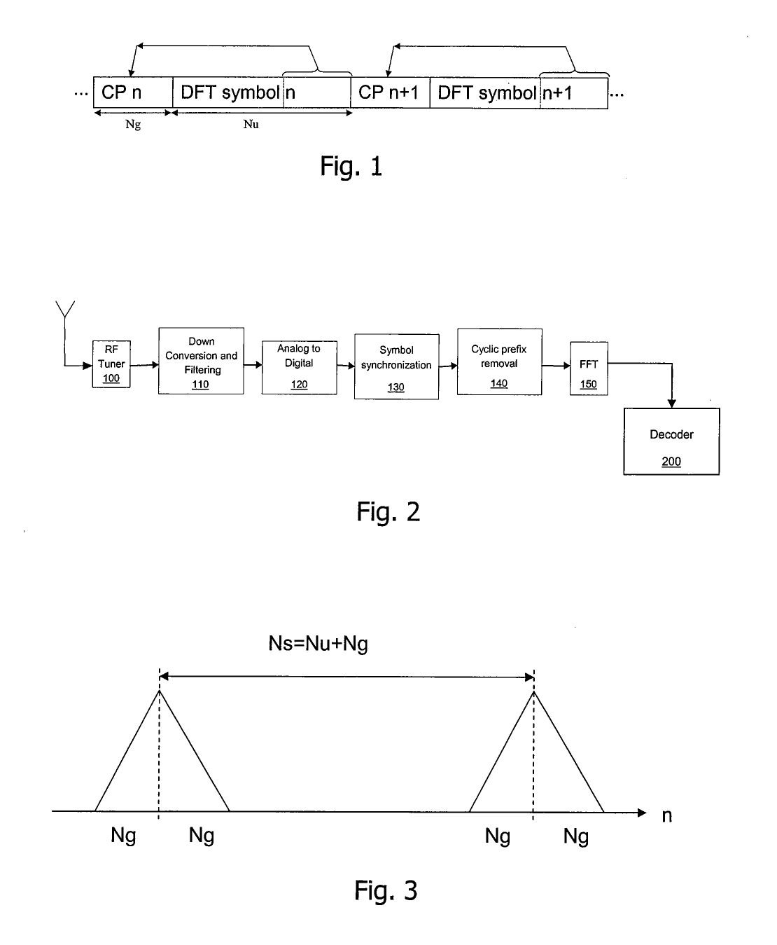

As depicted in FIG. 1, the Ng samples of CP are created by copying the last N_{g} samples in the DFT symbol. This property is used for symbol boundary identification. In one embodiment, the symbol synchronization block 130 may only be active at the start of channel acquisition to obtain the initial estimates of symbol timing. In another embodiment, the values of Nᵤ and N_{g} must be known prior to activating symbol synchronization block 130. Based on the identified symbol boundaries obtained using one of techniques of the present invention, the cyclic prefix removal block 140 removes the cyclic prefix samples from its input before feeding it to the FFT processing block 150.

Conventional techniques detect the OFDM symbol boundary mainly based on the peak correlation T(n) shown in Equation 2 above. Suppose the transmission channel has an impulse response CIR with length L_{CIR}. At the receiver, the first L_{CIR} samples of a symbol will be affected by the previous symbol. In fact, the last sample of the previous symbol affects the next L_{CIR} samples, which are the first L_{CIR} samples in CP. Therefore, as long as the impact of the last sample in the previous symbol on the current symbol is avoided, ISI is completely removed. Since the first Ng samples of a symbol are in CP that will be discarded before FFT, as long as L_{CIR}≦Ng, ISI is completely avoided if the symbol boundary is identified accurately. The impact of the last sample on the current symbol is in the shape of CIR.

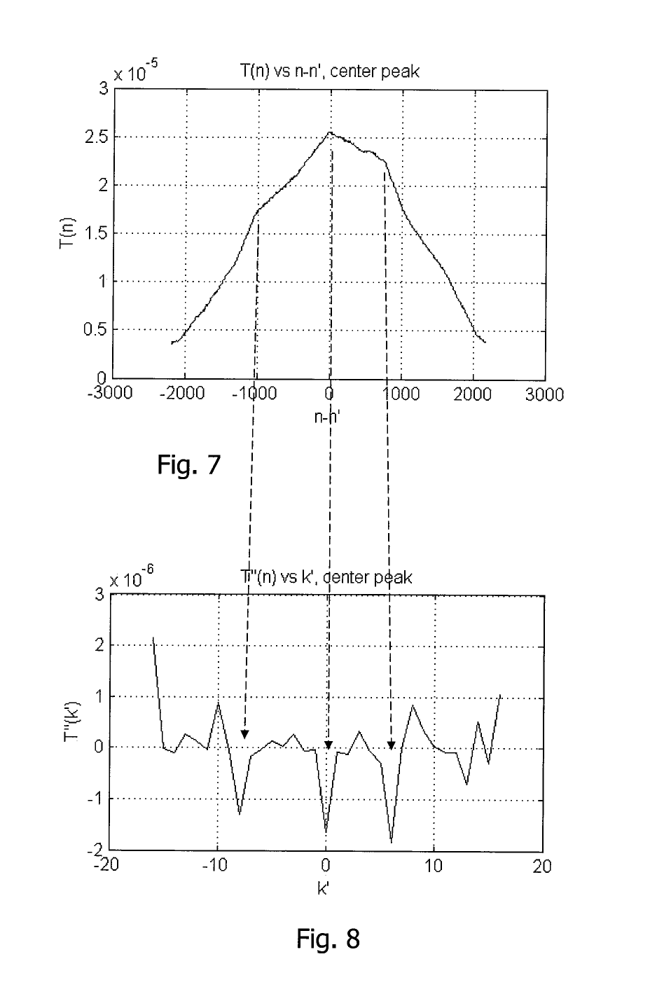

A main objective of the symbol synchronization, in accordance with embodiments of the invention, is to locate the channel impulse response (CIR) within CP, or locate as much energy of CIR within CP as possible. However, the peak correlation T(n) by itself does not easily show the CIR. For example, in FIG. 3 which shows an ideal channel with no distortion, the CIR is just an impulse, and the correlation T(n) has the shape of a triangle with its peak indicating the location of the symbol boundary. For severe channels however, the correlation T(n) by itself does not identify the location of the symbol boundary. FIG. 7 shows the correlation T(n) for an exemplary 3-path channel, where Nᵤ is 8,192, N_{g} is 2,048 and the channel is 90% of N_{g}. As can be seen, the CIR is not easily identifiable from the T(n) in FIG. 7.

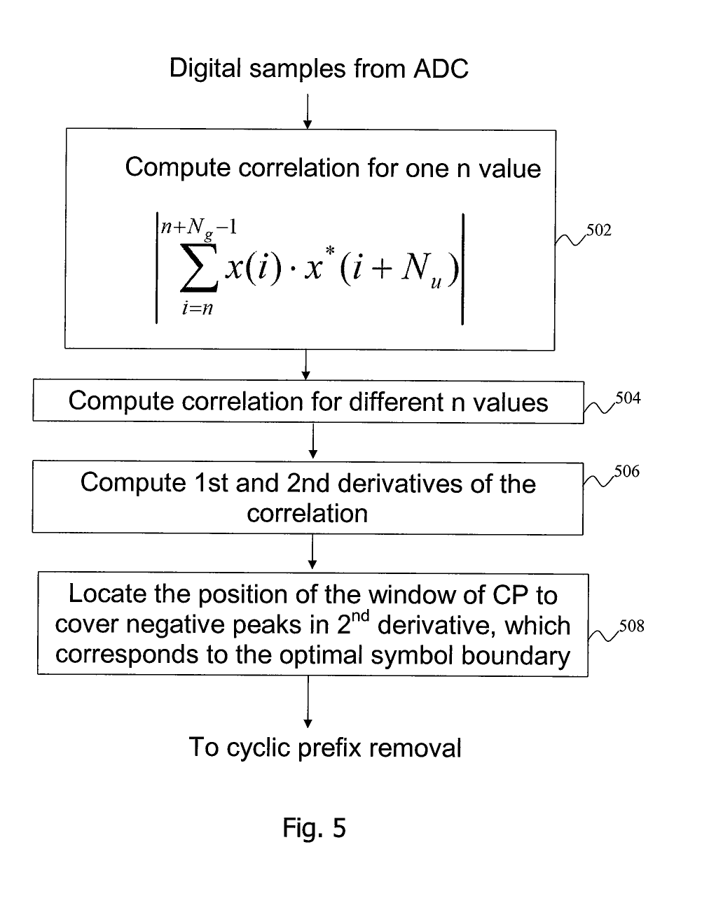

In accordance with a first embodiment of the invention, this problem is addressed as follows. The flow chart in FIG. 5 will be used in describing the first embodiment. Using the digital samples generated by the analog to digital converter block 120, correlation T(n) is calculated for one n value in step 502 and then for different n values in step 504, using known techniques. Based on the calculated T(n), the peak is found as n″₀. Then, in step 506, the first and second derivatives of T(n) are computed around n″₀, with a window of W samples on each side of n″₀. For example, W can be chosen to be equal to N_{g}. Since the difference between consecutive T(n) samples may be noisy, T′(n) and T″(n) are computed using samples that are Δ apart (n=k·Δ+n″₀ where Δ is an integer greater than or equal to 1, typically a power of 2), as indicated by Equation 3:
T′(n)=T(n)−T(n−Δ), n=k·Δ+n″₀,−r≦k≦r+1
T″(n)=T′(n+Δ)−T′(n), n=k·Δ+n″₀,−r≦k′≦r
where r is the integer part of W/Δ. Eq. (3)

Note that at the start of each group, the change in the slope of T(n) has a noticeable corresponding negative spike. These are marked by dashed arrows in FIGS. 7 and 8. These negative spikes represent the energy spikes in the CIR. By finding a window of Ng with the maximum spike energy, the CIR energy in CP is typically maximized. This feature can be exploited to obtain the final estimate of symbol start time, n₀, using Equation 4 below:

$${n}_{0} = {argmin}_{n} \{ f ( n ) \} - r Δ / 2 + τ , \\ f ( n ) = {\sum }_{i = - r / 2}^{r / 2} {T}^{″} ( n + i Δ ) , \\ n = k \cdot Δ + {n}_{0}^{″} , \\ - r / 2 \leq k \leq r / 2 \\ τ is an adjustment term , \\ e . g . , \\ τ = min \{ 16 , \frac{Δ}{2} \} \qquad Eq . ( 4 )$$

The minimum of ƒ(n) captures the window of N_{g} in length around n″₀ that contains most negative spikes, which corresponds to the maximum CIR energy, and indicates most likely placement of the channel CIR. Then the start of the channel is the beginning of this window, as shown in the computation of n₀ in Equation 4. The factor τ is the adjustment to n₀ due to the resolution of Δ, with a maximum value of 16 samples, in accordance with one embodiment.

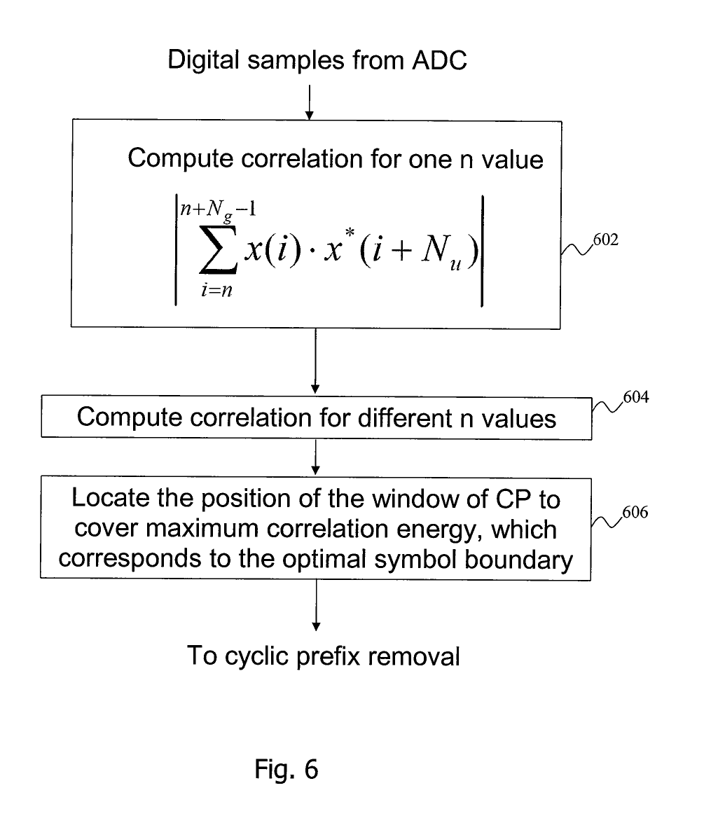

An alternate embodiment of the invention is depicted by the flow chart in FIG. 6. Initially, as in steps 502 and 504 of the FIG. 5 embodiment, using the digital samples generated by the analog to digital converter block 120, correlation T(n) is calculated for one n value in step 602 and then for different n values in step 604, using known techniques. The peak is then found as n″₀ based on the calculated T(n). In step 606, the window of Ng with the maximum correlation energy is calculated according to Equation 5:

$${n}_{0} = {argmax}_{n} \{ g ( n ) \} - r Δ / 2 + τ , \\ g ( n ) = {\sum }_{i = - r / 2}^{r / 2} T ( n + ⅈΔ ) , \\ n = k \cdot Δ + {n}_{0}^{″} , \\ - r / 2 \leq k \leq r / 2 \\ τ is an adjustment term , \\ e . g . , \\ τ = min \{ 16 , \frac{Δ}{2} \} \qquad Eq . ( 5 )$$

The two examples respectively depicted by FIGS. 7, 8 and 9, 10 will be used in conjunction with the ideal channel depicted in FIG. 3 to convey some of the features of the present invention. For an ideal channel depicted in FIG. 3, T″(k′) would simply be a negative spike, which is a clear indication of the CIR. For a multi-path channel, depicted by FIGS. 7-10, there are typically multiple spikes, indicating multi-paths in CIR. The FIGS. 7-10 examples, depict 3-path channels. In the examples depicted by FIGS. 7 and 8, the channel is comprised of a single frequency network (SFN—where the same frequency is used by transmitters in various locations) channel with three independent fading groups, each group being 5 μs long and representing the Raleigh fading signal emitting from a single transmitter at 5.4 dB C/N and 150 Hz Doppler. The groups are placed at 0, 0.5*N_{g} and 0.9*N_{g} apart, with the last tap of the channel being at 90% point of N_{g}. Its T(n) and T″(k′) are shown in FIGS. 7 and 8, respectively.

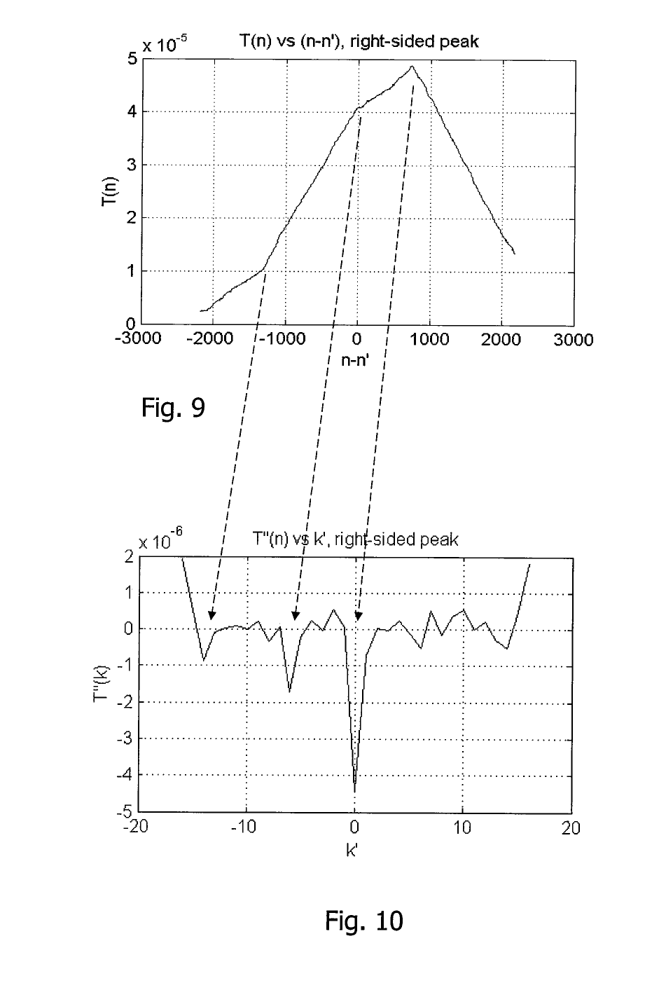

Because each group in the SFN channel is fading independently with various strengths, the peak of T(n) may not occur in the middle of the SFN groups. FIG. 9 shows the T(n) of a 3-path channel where there are three groups in CIR, and the largest peak is the third one. If the start of a symbol is solely determined by the peak of T(n) as in conventional approach, then an SFN channel realization that produces the T(n) illustrated in FIG. 9 will result in significant symbol misalignment and ISI. If the peak occurs at each group position with equal probability, then the probability of making a large timing misalignment using the convention peak correlation approach is ⅔. In accordance with an embodiment of the present invention, T″(k′) picks up the negative spike produced by all groups, including the very first group, as illustrated by the dashed arrows in FIGS. 9 and 10, thus enabling selecting a n₀ that is close to ideal. This better estimate of no results in significantly less ISI and therefore better overall system performance.

The performance of an exemplary symbol timing estimator measured by the mean channel energy captured (MCEC) within CP is summarized in Table 1. In Table 1, MCEC values are tabulated for SNR=5.4 dB, Doppler=150 Hz, Carrier Offset=1500 Hz, BW=8 MHz, 200 trials using the first embodiment in FIG. 5.

TABLE 1

| | Number of | | MCEC | | |
|---|---|---|---|---|---|
| L_{CIR}/N_{g} | Groups | N_{g}/Nᵤ | Nᵤ = 2K | Nᵤ = 4K | Nᵤ = 8K |
| 90% | 3 | ¼ | 97.5% | 99.2% | 99.1% |
| | | ⅛ | 95.2% | 97.6% | 97.0% |
| | 2 | ¼ | 99.4% | 99.8% | 99.7% |
| | | ⅛ | 92.2% | 98.5% | 98.3% |
| 50% | 3 | ¼ | 99.5% | 100.0% | 100.0% |
| | | ⅛ | 97.2% | 99.1% | 100.0% |
| | 2 | ¼ | 99.5% | 99.9% | 100.0% |
| | | ⅛ | 98.7% | 99.9% | 100.0% |

Each channel realization is an SFN channel with two or three independent Raleigh fading groups. The separation between the groups is about 50% of L_{CIR} in the three group case and about 95% of L_{CIR} in the two group case. The length of the CIR L_{CIR} is either 90% or 50% of N_{g}. N_{g} of length Nᵤ/4 and Nᵤ/8 are simulated as shorter guard intervals are not suitable for such an SFN operating environment. Compared to the performance of the conventional peak correlation method, which at best is 67% for three groups and 75% for two groups under channels that are 90% of N_{g} in length, the embodiments of the invention provide significant performance improvement.

Another way to gage the performance of the symbol timing estimator is the mean missed distance (MMD) in samples. The missed distance is defined as the difference between the estimated symbol start time and the edges of a “don't care” window. The right edge of the window represents the exact symbol start time, while the left edge of the window represents how much earlier the symbol start estimate can be compared to the exact start time without incurring any ISI. If the symbol start estimate falls outside of this window, then ISI occurs. The length of this window depends on the length of the guard interval length N_{g} and the length of the channel impulse response L_{CIR}.

Table 2 below summarizes the performance of the symbol timing estimator in terms of MMD under the same simulation conditions as in Table 1, using the first embodiment in FIG. 5. That is, Table 2 shows the MMD in samples for SNR=5.4 dB, Doppler=150 Hz, Carrier Offset=1500 Hz, BW=8 MHz, 200 trials, using the first embodiment in FIG. 5. Using conventional methods, the MMD in channels whose L_{CIR} are 90% of N_{g} in length are 46.7% and 45% of N_{g} for three and two groups, respectively. Again, compared to the convention method, the embodiments of the invention provide significant improvements when the channel length L_{CIR} exceeds 50% of N_{g}.

TABLE 2

| | Number of | | MMD | | |
|---|---|---|---|---|---|
| L_{CIR}/N_{g} | Groups | N_{g}/Nᵤ | Nᵤ = 2K | Nᵤ = 4K | Nᵤ = 8K |
| 90% | 3 | ¼ | 4.22 | 3.83 | 1.89 |
| | | ⅛ | 7.86 | 6.56 | 3.65 |
| | 2 | ¼ | 1.73 | 0.37 | 0.40 |
| | | ⅛ | 5.09 | 5.95 | 2.45 |
| 50% | 3 | ¼ | 0.13 | 0.00 | 0.00 |
| | | ⅛ | 1.55 | 0.67 | 0.14 |
| | 2 | ¼ | 0.14 | 0.86 | 0.00 |
| | | ⅛ | 1.45 | 0.02 | 0.14 |

Tables 3 and 4 below respectively tabulate simulated MCEC and MMD values obtained under the same simulation conditions as in Tables 1 and 2, using the alternate embodiment in FIG. 6.

TABLE 3

| | Number of | | MCEC | | |
|---|---|---|---|---|---|
| L_{CIR}/N_{g} | Groups | N_{g}/Nᵤ | Nᵤ = 2K | Nᵤ = 4K | Nᵤ = 8K |
| 90% | 3 | ¼ | 89.5% | 88.2% | 85.6% |
| | | ⅛ | 94.9% | 88.7% | 88.1% |
| | 2 | ¼ | 76.3% | 71.4% | 73.2% |
| | | ⅛ | 89.4% | 78.0% | 73.6% |
| 50% | 3 | ¼ | 100.0% | 100.0% | 100.0% |
| | | ⅛ | 100.0% | 100.0% | 100.0% |
| | 2 | ¼ | 100.0% | 100.0% | 100.0% |
| | | ⅛ | 100.0% | 100.0% | 100.0% |

TABLE 4

| | Number of | | MMD | | |
|---|---|---|---|---|---|
| L_{CIR}/N_{g} | Groups | N_{g}/Nᵤ | Nᵤ = 2K | Nᵤ = 4K | Nᵤ = 8K |
| 90% | 3 | ¼ | 19.3 | 38.3 | 80.0 |
| | | ⅛ | 6.4 | 18.8 | 36.6 |
| | 2 | ¼ | 46.4 | 103.2 | 175.5 |
| | | ⅛ | 16.6 | 44.7 | 89.7 |
| 50% | 3 | ¼ | 0.0 | 0.0 | 0.0 |
| | | ⅛ | 0.0 | 0.0 | 0.0 |
| | 2 | ¼ | 0.0 | 0.0 | 0.0 |
| | | ⅛ | 0.0 | 0.0 | 0.0 |

Tables 5 and 6 below respectively tabulate simulated MCEC and MMD values obtained under the same simulation conditions as in Tables 1-4, using the conventional method based on the peak of correlation.

TABLE 5

| | Number of | | MCEC | | |
|---|---|---|---|---|---|
| L_{CIR}/N_{g} | Groups | N_{g}/Nᵤ | Nᵤ = 2K | Nᵤ = 4K | Nᵤ = 8K |
| 90% | 3 | ¼ | 45.1% | 47.1% | 45.7% |
| | | ⅛ | 49.0% | 46.6% | 37.5% |
| | 2 | ¼ | 47.5% | 49.6% | 42.0% |
| | | ⅛ | 45.1% | 49.1% | 31.6% |
| 50% | 3 | ¼ | 46.8% | 45.3% | 46.9% |
| | | ⅛ | 45.5% | 46.6% | 45.3% |
| | 2 | ¼ | 45.8% | 51.7% | 44.8% |
| | | ⅛ | 46.2% | 49.8% | 42.9% |

TABLE 6

| Channel | | | | | |
|---|---|---|---|---|---|
| Length | Number of | | MMD | | |
| (in N_{g}) | Groups | N_{g}/Nᵤ | Nᵤ = 2K | Nᵤ = 4K | Nᵤ = 8K |
| 90% | 3 | ¼ | 260.9 | 480.1 | 1025.3 |
| | | ⅛ | 131.3 | 265.1 | 512.6 |
| | 2 | ¼ | 187.1 | 451.1 | 1075.2 |
| | | ⅛ | 95.0 | 213.1 | 492.0 |
| 50% | 3 | ¼ | 145.2 | 288.5 | 582.2 |
| | | ⅛ | 71.5 | 152.2 | 289.8 |
| | 2 | ¼ | 112.7 | 198.0 | 529.2 |
| | | ⅛ | 52.0 | 122.5 | 218.1 |

The performance of the symbol timing estimator is also evaluated under a static channel condition with only one group, as shown in Tables 7 and 8. In Tables 7 and 8, MCEC and MMD values are tabulated for SNR=5.4 dB, Carrier Offset=1500 Hz, BW=8 MHz, single group, 200 trials using the first embodiment in FIG. 5. The length of the group is about 3.3 μs and the channel bandwidth is 8 MHz. If N_{g} is 1/16 of Nᵤ, the channel length L_{CIR} is about 24%, 12% and 6% of N_{g} for FFT sizes of 2K, 4K and 8K, respectively. If N_{g} is 1/32 of Nᵤ, then the ratios between the channel length and N_{g} are doubled. As can be seen, the symbol timing estimator still performs well under these conditions.

TABLE 7

| | MCEC | | |
|---|---|---|---|
| N_{g}/Nᵤ | Nᵤ = 2K | Nᵤ = 4K | Nᵤ = 8K |
| 1/16 | 99.89% | 100.0% | 100.0% |
| 1/32 | 98.28% | 99.9% | 100.0% |

TABLE 8

| | MMD | | |
|---|---|---|---|
| N_{g}/Nᵤ | Nᵤ = 2K | Nᵤ = 4K | Nᵤ = 8K |
| 1/16 | 0.02 | 0.00 | 0.00 |
| 1/32 | 7.87 | 0.30 | 0.00 |

Tables 9 and 10 below respectively tabulate simulated MCEC and MMD values obtained under the same simulation conditions as in Tables 7 and 8, using the alternate embodiment in FIG. 6.

TABLE 9

| | MCEC | | |
|---|---|---|---|
| N_{g}/Nᵤ | Nᵤ = 2K | Nᵤ = 4K | Nᵤ = 8K |
| 1/16 | 100.0% | 100.0% | 100.0% |
| 1/32 | 99.9% | 100.0% | 100.0% |

TABLE 10

| | MMD | | |
|---|---|---|---|
| N_{g}/Nᵤ | Nᵤ = 2K | Nᵤ = 4K | Nᵤ = 8K |
| 1/16 | 0.00 | 0.00 | 0.00 |
| 1/32 | 0.40 | 0.00 | 0.00 |

Tables 11 and 12 below respectively tabulate simulated MCEC and MMD values obtained under the same simulation conditions as in Tables 7-10, using the conventional method based on the peak of correlation.

TABLE 11

| | MCEC | | |
|---|---|---|---|
| N_{g}/Nᵤ | Nᵤ = 2K | Nᵤ = 4K | Nᵤ = 8K |
| 1/16 | 89.7% | 68.9% | 95.8% |
| 1/32 | 85.3% | 89.1% | 91.5% |

TABLE 12

| | MMD | | |
|---|---|---|---|
| N_{g}/Nᵤ | Nᵤ = 2K | Nᵤ = 4K | Nᵤ = 8K |
| 1/16 | 0.66 | 1.16 | 0.74 |
| 1/32 | 1.15 | 1.30 | 1.37 |

From these results, it can be seen that the embodiments of the present invention outperform conventional techniques by a large margin, especially in the presence of severe wireless channels.

While the above provides a complete description of the preferred embodiments of the invention, many alternatives, modifications, and equivalents are possible. Further, the features of one or more embodiments of the invention may be combined with one or more features of other embodiments of the invention without departing from the scope of the invention. For these and other reasons, therefore, the above description should not be taken as limiting the scope of the invention, which is defined by the appended claims.

What is claimed is:

1. A method for symbol synchronization in a communication system, the method comprising:
receiving a plurality of symbols corresponding to a transmitted signal, the plurality of symbols including guard intervals;
obtaining peak correlation using the plurality of received symbols;
obtaining the second derivative of the peak correlation to identify one or more peaks each corresponding to a channel impulse response within a guard interval; and
estimating a symbol start time for each received symbol based on the second derivative of the peak correlation.

2. The method of claim 1 further comprising:
locating a position of a window of predetermined number of samples to cover the one or more peaks.

3. The method of claim 2 wherein the predetermined number of samples is equal to or less than guard interval samples.

4. The method of claim 1 further comprising:
using the second derivative of the peak correlation, identifying a window of a corresponding guard interval with a maximum spike energy.

5. The method of claim 1 wherein the plurality of symbols are OFDM symbols.

6. The method of claim 1 wherein the one or more peaks are negative peaks.

7. The method of claim 1 wherein first and second derivatives of the peak correlation are obtained using samples that are apart from one another a predetermined number of samples.

8. The method of claim 1 further comprising:
after estimating the symbol start time, removing the guard intervals from the plurality of symbols.

9. A method for symbol synchronization in a communication system, the method comprising:
receiving a plurality of symbols corresponding to a transmitted signal, the plurality of symbols including guard intervals;
obtaining peak correlation using the plurality of received symbols;
obtaining the second derivative of the peak correlation to identify one or more peaks within a corresponding guard interval; and
estimating a symbol start time for each received symbol based on the second derivative of the peak correlation.

10. The method of claim 9 further comprising:
locating a position of a window of predetermined number of samples to cover the one or more peaks.

11. The method of claim 10 wherein the predetermined number of samples is equal to or less than guard interval samples.

12. The method of claim 9 further comprising:
using the second derivative of the peak correlation, identifying a window of a corresponding guard interval with a maximum spike energy.

13. The method of claim 9 wherein the plurality of symbols are OFDM symbols.

14. The method of claim 9 wherein the one or more peaks are negative peaks.

15. The method of claim 9 wherein first and second derivatives of the peak correlation are obtained using samples that are apart from one another a predetermined number of samples.

16. The method of claim 9 further comprising:
after estimating the symbol start time, removing the guard intervals from the plurality of symbols.

17. A method for symbol synchronization in a communication system, the method comprising:
receiving a plurality of symbols corresponding to a transmitted signal, the plurality of symbols including guard intervals;
obtaining peak correlation using the plurality of received symbols;
in each guard interval, obtaining a window of samples with the maximum correlation energy based on the peak correlation; and
estimating a symbol start time for each received symbol using the obtained samples.

18. The method of claim 17 wherein the window of samples is equal to or less than guard interval samples.

19. The method of claim 17 wherein the plurality of symbols are OFDM symbols.

20. The method of claim 17 further comprising:
after estimating the symbol start time, removing the guard intervals from the plurality of symbols.
